(19) United States
(12) Patent Application Publication
(10) Pub. No.: US 2025/0000048 A1
(43) Pub. Date: Jan. 2, 2025

(54) PATH BOUNDARY FOR DIRECTED ANIMAL TRAFFIC

(71) Applicant: GEA Farm Technologies GmbH, Bönen (DE)

(72) Inventors: Michael Strotmann, Billerbeck (DE); Johannes Otteloh, Beckum (DE)

(21) Appl. No.: 18/709,898

(22) PCT Filed: Oct. 27, 2022
(86) PCT No.: PCT/EP2022/080057

§ 371 Date: May 14, 2024

(30) Foreign Application Priority Data
Nov. 19, 2021 (DE) 102021130321.4

(51) Int. Cl. A01K 1/00; A01K 1/12

(52) U.S. Cl. CPC A01K 1/0023; A01K 1/12

(57) ABSTRACT

The invention relates to a pivotable path boundary (15) for directed animal traffic and for singling out animals of different size, said path boundary allowing the path width to be adjusted easily and with low risk to humans and animals. A path boundary is provided which allows variability of the width of the path without complex conversion measures. The invention is used in particular to organize animals in the entry region of milking parlors and treatment stands.

The object of the invention is a path boundary for controlled animal traffic, a milking system having a path boundary and a method for directing animal traffic.

Agricultural holdings often have a fully developed animal traffic directing system, which connects the different areas of the holding to one another. To this end, an infrastructure comprising walkways, boundary gates and gates which connects different areas, such as feeding and milking areas, to one another, is provided. The path boundary according to the invention is suitable for influencing animal traffic, for example cow, goat or buffalo traffic.

Within an agricultural holding, in particular a dairy farm, it may be necessary for the animals to enter certain areas separately or in small groups. To achieve this, walkways are provided whereof the width is selected according to the herd. This enables the animals to be reduced in number or separated.

Since, animals within a specialized holding, for example milking cows, may also vary significantly in terms of their size, walkways with a static width are disadvantageous in that they have to be selected to be large enough for the largest animals to be able to move along the walkways voluntarily and without injury. However, if the selected path width is too large, younger and/or slimmer animals might squeeze through next to one another at the same time so that, in this case, the aim of separating the animals may not be achieved. As a rule, walkways of this type are currently planned with a fixed width which, if in doubt, is unsuitable for certain animal sizes. A fixed width may merely be a compromise if a path is intended to be used by groups of animals of different size.

The following statements focus on the use of the invention within the context of dairy farms. Instead of milking parlors, treatment stalls, for example for hoof trimming, may also be provided, to which animals should be directed individually or in small groups.

A dairy farm commonly comprises multiple herds. Apart from calves and youngstock, a typical dairy farm includes at least one group of heifers (sexually mature female cattle before their first calving), cows in calf and milking cows in different phases of lactation. The above-mentioned animal groups may differ significantly in terms of the average individual height and width.

Cows to which certain properties are attributed may be grouped together. Such properties may be a similar milking performance or milking time, for example.

The separation of the animals is particularly important in relation to the occupancy of stalls in a rotary milking parlor. As a rule, each cow is identified as it enters the rotary milking parlor and the milking clusters are programmed according to the individual milking performance or milking time, for example, The identification of an animal may take place, in particular, via animal-specific detection means, which each animal wears on the ear, around the neck, around a foot, etc. These may be detected, for example, electronically by a reader unit or manually. The detection point may be at the start of a path leading to a milking parlor, for example. It is necessary to separate the cows so that the cows approach a rotary milking parlor in an orderly manner. By separating the animals, the aim is to prevent multiple animals from being able to occupy one milking stall or to prevent a possible change in the order of the animals in the rotary milking parlor. In this regard, it is crucially important that the animals are no longer able to change position between the point at which they are detected and the milking stall so as to prevent the incorrect assignment of milking program to animal.

Furthermore, the aim is to prevent the animals from backing up and blocking the access to the milking stalls so that milking stalls remain empty. This would lower the animal throughput and be in conflict with the aim of utilizing the milking systems as efficiently as possible.

The present invention is based on the object of controlling animal traffic and enabling reliable separation of the animals. To this end, a path boundary, a milking system and methods are proposed.

The object is achieved by the features of the independent claims. The dependent claims focus on advantageous developments of the invention.

The path boundary according to the invention serves for directing animal traffic in a movement direction. It comprises a first and a second boundary gate. The first boundary gate is situated opposite the second, so that a path is enclosed between the two boundary gates. The boundary gates may be arranged parallel to one another. They may also be oriented at an angle to one another so that they bring about a certain narrowing or widening of a path.

The path boundary has at least one guide unit projecting into the path. This extends in the movement direction and has a geometry such that a spacing between the guide unit and the opposing boundary gate is reduced as seen in the movement direction. As a result, it is possible for the animals to move comfortably along the path—which narrows in the movement direction, in particular tapers continuously—without significantly changing direction.

A positioning unit is provided, which is suitable and intended for altering a position of the guide unit. By adjusting the position of the guide unit, a spacing between the guide unit and the boundary gate opposite the guide unit can be changed. The positioning of the guide unit determines the width of the path at this point. The animal traffic can thus be regulated such that the animals may pass through this point individually. The animals are consequently separated.

It is not imperative for the guide unit to be connected directly to the boundary gate. It is advantageous for the guide unit to be connected to the positioning unit. An assembly comprising the guide unit and the positioning unit is therefore created, which is fastened to the boundary gate. The fastening of the positioning unit to the boundary gate may be realized, for example, by a screw connection.

According to a further advantageous configuration of the path boundary according to the invention, the guide unit comprises a bow-shaped piece. In the context of this document, a bow-shaped piece is understood to be a structure which is formed by at least one pipe and is bent or constructed such that it has a convex and a concave region, wherein the convex region is oriented in the direction of the opposing boundary gate.

The bow-shaped piece may advantageously also be formed by two identically designed pipes, which are arranged at a spacing, one above the other, and are connected to one another by further pipe sections. Since the bow-shaped piece is relatively large in size, it is more easily noticed by the animals. As a result, the animals are better able to avoid the bow-shaped piece and the risk of heavy impacts is reduced.

According to an advantageous configuration of the path boundary according to the invention, the guide unit is swivel-mounted. The mounting may be realized along a vertical pivot axis. To this end, the positioning unit may comprise a pivot bearing and an arresting means arranged at a spacing from the pivot bearing, which pivot bearing and arresting means are connected to the second boundary gate. According to this configuration, the swivel angle is continuously variable. The guide unit may be fixed in any position via the arresting means.

According to an alternative advantageous configuration, the guide unit comprises at least one joint and two limbs, which are connected to one another via the joint. The limbs, together with the joint, form an assembly which is connected to the positioning unit at its two ends. According to this configuration, the positioning unit comprises a fixed bearing at a first fastening point and a floating bearing at a second fastening point, to which floating bearing the guide unit is pivotably and displaceably connected.

Through a displacement of the guide unit at the second fastening point, which is positioned at a spacing from the first point, an angle between the limbs is altered. The angle, and therefore the horizontal extent of the guide unit orthogonally to the movement direction, changes depending on the position, which results in a widening or narrowing of the path.

According to an alternative advantageous configuration, the guide unit may be positioned in various positions and angles relative to a boundary gate. This may be achieved, for example, by a guide unit which is formed by multiple elements and angle joints. This may be particularly advantageous if the surrounding environment has limited space. In such a configuration, it is not necessary to keep a swivel area free, which means that it can be realized in a comparatively space-saving manner.

According to a further advantageous configuration of the path boundary according to the invention, the guide unit is freely displaceable in a horizontal plane. At least one concertina grille may be provided for this purpose, via which the guide unit is mounted on the second boundary gate or on another fixed supporting structure. The concertina grille may be designed such that it comprises multiple concertina arms, which are arranged in a criss-cross manner, one above the other, are connected to one another, for example, by screws, sleeves, bolts or rivets, and can be slid together and apart so that the extent of the concertina grill is variable in at least one dimension.

All presented embodiments of the path boundary are advantageous in that they can be retrofitted in existing boundary gates.

According to a further advantageous configuration of the path boundary according to the invention, the positioning unit comprises an arresting means with which the guide unit can be fixed in a set position. This arresting means may be connected to the boundary gate such that it is static or displaceable. The guide unit can be connected to the arresting means such that the guide unit is fixed at at least two points and is therefore held in a static manner. If the guide unit is capable of swiveling, a movement of the guide unit about the swivel axis can be blocked by the arresting means.

The separation of the animals highly important, in particular in connection with rotary milking parlors and group milking stalls. As a rule, the animals are firstly driven out of the barn or from the field and into a waiting area in which they are able to move freely and wander around. From there, they are driven in the direction of the milking system via a route which is delimited on both sides-amongst other things, with the aim of separating them. The separation may take place, in particular, via the path boundary according to the invention.

According to a further inventive idea, a milking system comprising at least one milking stall and an access area is proposed. The milking stall may be, for example, part of a group milking stall or rotary milking parlor. The access area is fitted with a path boundary for directing animal traffic in a movement direction. The above statements relating to the path boundary are also associated with the milking system according to the invention.

According to a further inventive idea, a method is proposed with which the width of the path can be influenced according to which animals will be walking along the path. To this end, stored animal parameters, such as the width or length of these animals, are accessed.

According to this configuration of the path boundary according to the invention, the positioning unit may have a drive means. With the aid of the drive means, an adjustment of the guide unit may take place in at least partially automated manner. The drive may be an electric, pneumatic or hydraulic drive, for example. The pneumatic or hydraulic drive may comprise a piston-cylinder system. Further possible configurations and different drives are possible.

Firstly, each animal which is in a specifiable area of a path along which the animal is intended to move is detected. The detection may take place via animal-specific detection means, for example a chip worn by the animal, which is detected by a reader unit. Animal-specific parameters of all detected animals are retrieved from a database. From this, a suitable path width may be ascertained, which enables a certain traffic flow. System-specific parameters, for example a rotation speed of a rotary milking parlor, may be included when ascertaining a setpoint path width. A tolerance value range may be specified, within which a deviation between the setpoint path width and the actual path width is accepted without undertaking any action. If the deviation between the setpoint path width and the actual path width exceeds the tolerance value range, the positioning unit is activated and a new path width is set. The method is repeated for as long as animals remain in the specified area.

The presented path boundary and milking system and the presented method enable the traffic flow to be influenced. This may take place in a manner which is calmer and therefore less stressful for the animals. By saving on complex modifications of walkways and paths when there is a change in the group or herd, the manpower requirement is reduced. The requirements of the invention, to achieve greater control in the entry area of rotary milking parlors, milk stalls and treatment stalls, and thus ultimately improve the utilization of the devices, are achieved by the features of the invention.

The invention and the technical sphere are explained in more detail with reference to the figures. The figures show particularly preferred exemplary embodiments, although the invention is not restricted to these. Identical reference signs denote identical objects, so explanations from other figures may be used in a supplementary manner, if necessary.

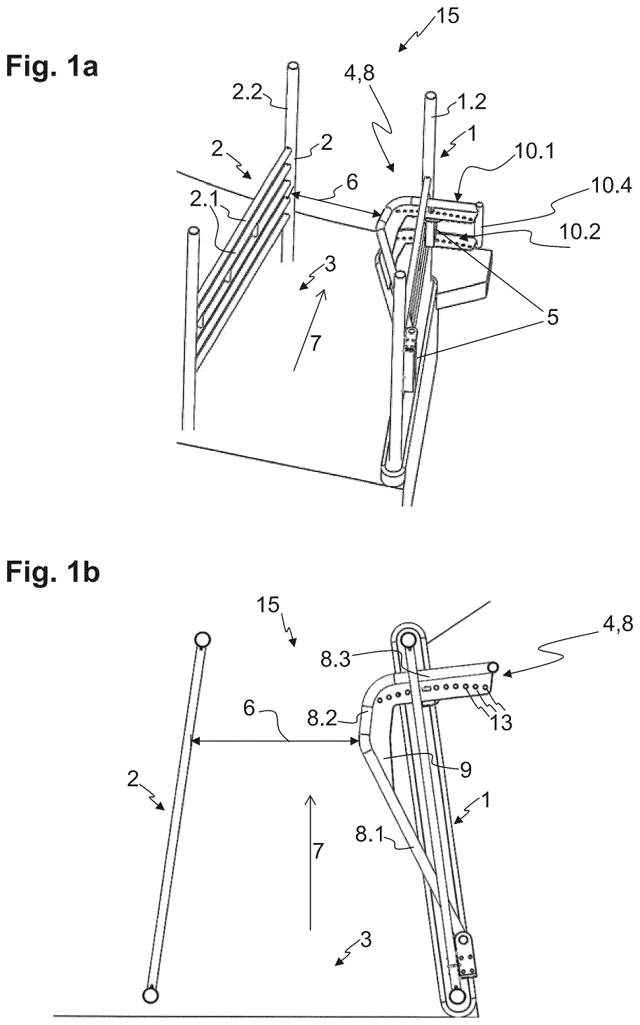

FIG. 1a shows a schematic, perspective view of a first configuration of the path boundary;

FIG. 1b: shows the first configuration of the path boundary in a plan view;

FIG. 1c: shows a perspective detailed view of the first configuration of the path boundary;

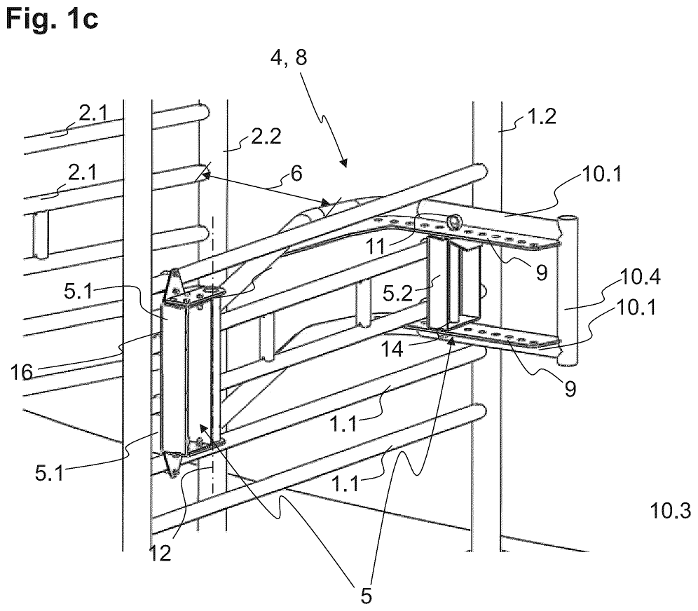

FIG. 2 shows a second configuration of a path boundary according to the invention in a plan view;

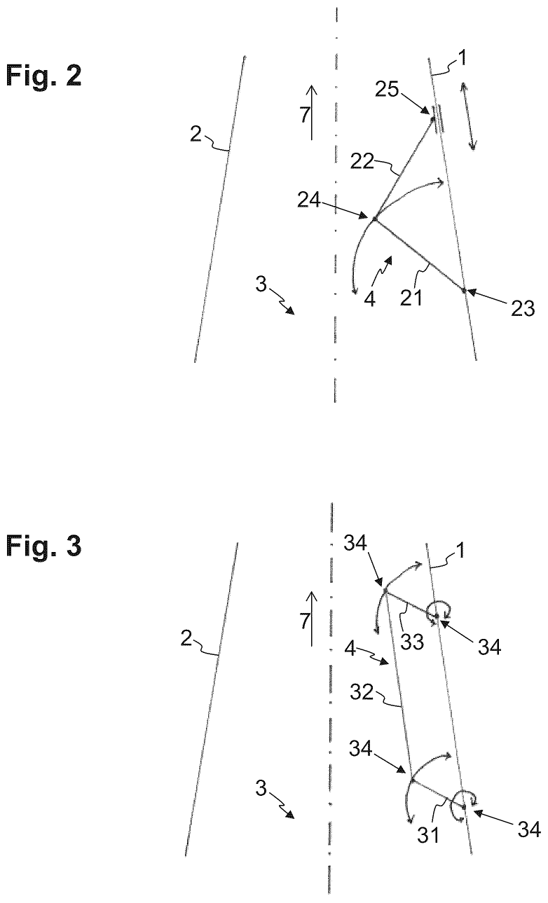

FIG. 3 shows a third configuration of a path boundary according to the invention in a plan view;

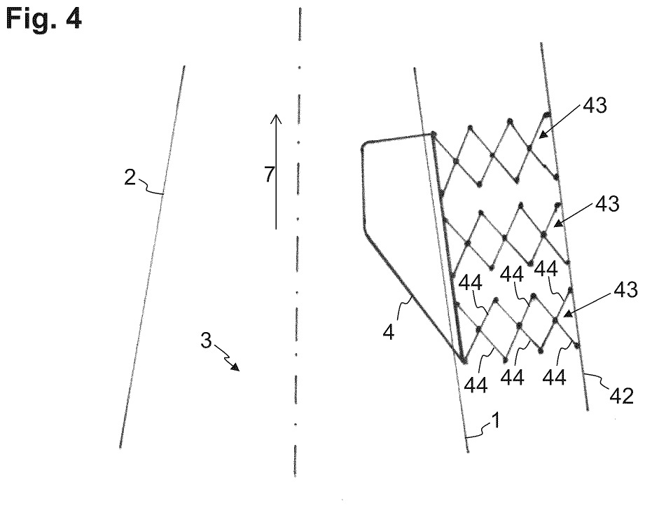

FIG. 4 shows a fourth configuration of a path boundary according to the invention in a plan view;

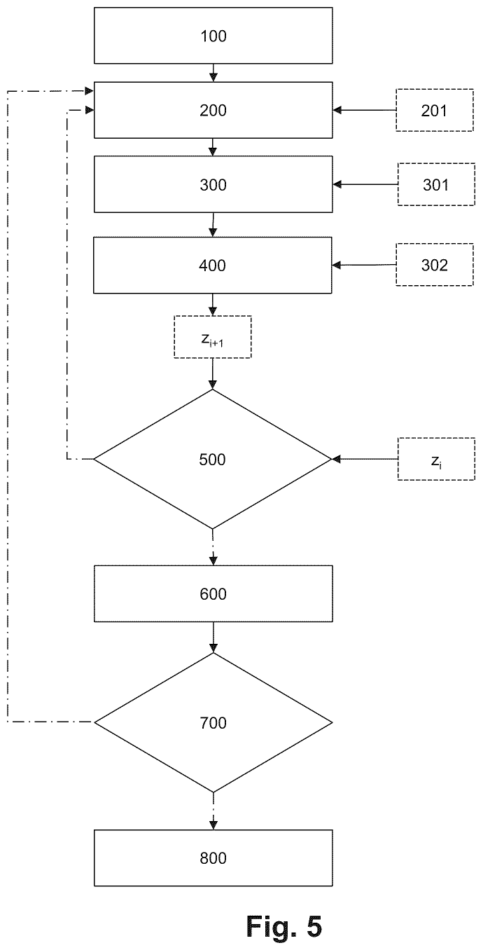

FIG. 5 shows a possible process sequence plan for carrying out the method according to the invention.

Unless reference is made explicitly to one of the figures, the following statements apply to all figures.

The FIGS. 1a, 1b and 1c each show schematically different views of a path boundary according to the invention. The path boundary 15 comprises a first 1 and a second 2 boundary gate, which enclose a path 3 on two opposite sides. The path 3 is provided for animals to move along it in a movement direction 7. Each boundary gate 1, 2 in this exemplary embodiment is formed by a structure which comprises a plurality of horizontally arranged pipes 1.1 and 2.1. The pipes 1.1 or 2.1 are held equidistantly parallel, one above the other, by two posts 1.2 and 2.2 in each case. The posts 1.2 and 2.2 hold the pipes 1.1 and 2.1 at their ends. The connection may be formed as a push-in connection and/or as a weld connection.

The path boundary 15 comprises a guide unit 4, which is designed as a bow-shaped piece 8 here. The bow-shaped piece 8 is formed by two identical elements 10.1 and 10.2, which are positioned one above the other and are connected to one another. Both elements 10.1 and 10.2 are connected to one another by two end pieces 10.3 and 10.4. The end pieces 10.3 and 10.4 are each formed by a linear pipe section, which extends along a vertical axis.

The bow-shaped piece 8 can be divided into three portions 8.1, 8.2 and 8.3. These can be seen particularly clearly in FIG. 1b. The three portions 8.1, 8.2 and 8.3 are formed by linear pipe sections, which are connected to one another by bent pipe sections. In the position illustrated by FIGS. 1a, 1b and 1c, the first portion 8.1 brings about a narrowing of the path 3. Between the first portion 8.1 and the first boundary gate 1, an angle is enclosed within the path 3. As a result, the spacing between the bow-shaped piece 8 and the second boundary gate 2 is reduced in the movement direction.

A connecting piece, bent in the direction of the first boundary gate, is arranged between the first portion 8.1 and the second portion 8.2. The second portion 8.2 extends approximately along the movement direction 7. The second portion 8.2 has the function of determining the width of the path 3 over the length of the portion 8.2 and directing the animals accordingly.

The third portion 8.3 adjoins the second portion 8.2 via a second bent connecting piece. The bend is again oriented in the direction of the first boundary gate 1, so that the width of the path 3 behind the second portion 8.2 becomes greater again. Since the animals should already be separated in the region of the third portion 8.3 and in the further movement direction 8, it is no longer imperative to narrow the width of the path 3 from this point.

As a result of the geometry described above, the bow-shaped piece 8 has a convex and a concave region, wherein the convex region is oriented in the direction of the second boundary gate.

On its concave side, the bow-shaped piece has perforated metal plates 9 on each of its elements. In the illustrated exemplary embodiment, these extend over the second 8.2 and third 8.3 portion of the bow-shaped piece. Each perforated metal plate 9 has a plurality of holes 13 arranged equidistantly along an imaginary circular path. The holes 13 are positioned in the region of the third portion 8.3.

The bow-shaped piece 8 is connected to a positioning unit such that it is mounted to be pivotable about a vertical pivot axis 12. The positioning unit 5 comprises a pivot bearing 5.1 and, spaced from the pivot bearing 5.1, an arresting means 5.2.

The pivot bearing 5.1 is connected to the first boundary gate 1 in a static manner by a screw connection, for example. The bow-shaped piece 8 is connected to the pivot bearing 5.1 such that it is pivotably mounted. The connection between the bow-shaped piece 8 and the pivot bearing 5.1 may be realized via the end piece 10.3, for example. The end piece 10.3 may be hollow or at least open towards the bottom in order to mount a holding element (not illustrated here) which is located along the pivot axis 12 on the pivot bearing 5.1. Alternatively, for example, at least one rolling bearing may be installed between the pivot bearing 5.1 and the end piece 10.3 in order to ensure a swivel capability.

The arresting means 5.2 is connected to the first boundary gate 1 so as to be horizontally displaceable along the first boundary gate 1. The arresting means 5.2 is located outside the gate 3 so that it is accessible for an operator without any need to reach into the path and be exposed to a potential injury risk through collision with animals. In this embodiment, the arresting means 5.2 is configured as a hollow cuboid, which is open to one side. The arresting means 5.2 has two passages 14, through which a locking pin 11 can be guided. The locking pin 1 comprises, at its upper end, a ring which is greater than the diameter of the holes 13 and passages 14 of the arresting means 5.2.

The perforated metal plates 9 of the bow-shaped piece 8 are arranged such that each pair of holes, which is formed in each case by two holes 13 at the same point on the two identical perforated metal plates 9, may lie on an imaginary straight line together with the two passages 14 of the arresting means 5.2. The locking pin 11 is able, and intended, to be guided along these straight lines and to fix the bow-shaped piece 8 and the arresting means 5.2 in a certain position with respect to one another.

FIG. 2 shows an alternative embodiment of the path boundary according to the invention in a plan view. In this, the guide unit 4 comprises two limbs 21 and 22, which are connected to one another. The guide unit 4 according to this embodiment has a joint 24, which is connected to a second end of the first limb 21 and to a first end of the second limb 22. A first end of the first limb 21 is pivotably connected to a fixed bearing 23, which is integrated in the first boundary gate 1.

A second end of the second limb 22 is connected to a floating bearing 25, which enables a displacement along the first boundary gate 1. A rail may be formed on the first boundary gate 1 for this purpose. Alternatively, the floating bearing may annularly enclose a horizontally arranged pipe of the first boundary gate 1.

The extent of the guide unit 4 orthogonally to the movement direction can be set via the displacement of the second end of the second limb 22. The first limb 21 here is displaced radially about the pivot point on the fixed bearing 23. The width of the passage is thus regulated.

In FIG. 3, a further alternative configuration of the path boundary is shown in a plan view. This variant also differs in terms of the geometry of the guide unit 4 and the mechanism via which the guide unit 4 can be positioned.

The guide unit 4 according to this embodiment has three elements 31, 32 and 33 and four angle joints 34. The second element 32 in the position shown is positioned parallel to the first boundary gage 1 and, still in a parallel position, may be displaced by moving the first element 31 radially about an angle joint 34.1 and the third element 33 radially about an angle joint 34.4. As a result of the four angle joints 34, a change in the position of the second element 32 relative to the first boundary gate 1 may also take place, so that these are no longer parallel to one another but at an angle to one another which makes the path narrower or wider.

FIG. 4 shows an alternative embodiment of the path boundary according to the invention. The guide unit 4 here may be formed by different static structures. In the illustrated example a bow-shaped structure is shown, which is also used in the examples according to FIGS. 1a to 1c. However, this is not integrated in the second boundary gate so as to be pivotably mounted, but is connected to multiple concertina grilles 43 at six points. The concertina grilles 43 are fastened to a stationary supporting structure 42. This may be a wall or an auxiliary structure, for example. It is also possible to fasten the concertina grilles 43 to the first boundary gate 1.

A concertina grille 43 comprises a plurality of flat concertina arms 44, which are arranged in a criss-cross manner and are connected to one another at multiple points. The connection may be realized by a sleeve, which is pushed through a bore. Each concertina arm 44 is either connected to three further concertina arms 44 or two concertina arms 44 and the guide unit 4 or the supporting structure 42. A point at which two concertina arms 44 are connected to one another or a concertina arm 44 is connected to the guide unit 4 or to the supporting structure 42 is a connecting point or connecting node. The concertina arms 44 can be moved radially about each connecting point.

The connection to the guide unit 4 or supporting structure 42 may be realized, for example, via perforated metal plates fastened to the guide unit 4 or to the supporting structure. The guide unit 4 is freely displaceable in a horizontal plane via a concertina grille 43. The concertina arms 44 can be slid freely together and apart so that the extent of the concertina grille is variable in a plurality of directions. In the example illustrated in FIG. 4, the guide unit 4 is connected to three concertina grilles 43. This number is exemplary and preferred. The concertina grilles 43 may also be expanded or collapsed to varying extents so that an angle between the guide unit 4 and the first boundary gate 1 may be altered.

A possible method sequence including the path boundary according to the invention is illustrated in FIG. 5. In this, method steps are shown in boxes with solid lines and parameters are shown in boxes with dashed lines. Further process steps which are required to follow a process step are linked by a solid arrow. If there are two options which are mutually exclusive, this is denoted by arrows with dot and dash lines. Steps in which an action is executed are shown in solid rectangles and decision steps are shown in diamonds.

According to this method, after the process start 100, detection of individual animals 200 which are still in the detection area 201 takes place. This area may be part of a waiting yard in front of a milking system, for example. An animal may be detected or identified using animal-specific detection means, as are already known. These may be detected by a receiver via wireless transmission.

Based on this, animal-specific parameters 301 may be retrieved from a database 300 when the database is accessed. These data are used to determine a setpoint opening width of the path zᵢ₊₁ during data processing 400. Animal-specific parameters 301 which are taken into account when ascertaining the setpoint opening width of the path zᵢ₊₁ may be animal width or length, for example. System-specific parameters 302, such as a current or setpoint rotation speed of a rotary milking parlor may also be included in the data processing 400.

In a subsequent process step, the comparison of the parameters zᵢ and zᵢ₊₁ 500, the actual opening width of the path zᵢ is compared with the setpoint opening width zᵢ₊₁ which has just been ascertained. If the two parameters are the same, the method continues with the renewed detection of individual animals 200 and the subsequent steps. If the parameters are different, in method step 600, the positioning unit 5 is activated and the setpoint opening width of the path zᵢ₊₁ is set. To prevent constant activation of the positioning unit 5, a tolerance value range between the actual and setpoint opening width may be specified, which must be exceeded in order to carry out the process step 600.

After activation of the positioning unit 600, there is a query 700 as to whether at least one animal is still located in the detection area 201. If this is the case, the method is initiated again when individual animals 200 are detected. If there are no longer any animals in the detection area, the process end 800 is reached.

The subject matter of the invention is a swivel-mounted path boundary for controlled animal traffic and for separating animals of different sizes, which enables the path width to be set easily and with little risk to human and animal. A path boundary is provided, which enables the width of the path to be varied without complex conversion methods. The invention serves, in particular, for organizing animals in the entry area of milking and treatment stalls.

### LIST OF REFERENCE SIGNS

1 First boundary gate
1.1 Pipes of the first boundary gate
1.2 Post of the first boundary gate
2 Second boundary gate
2.1 Pipes of the second boundary gate
2.2 Post of the second boundary gate
3 Path
4 Guide unit
5 Positioning unit
5.1 Pivot bearing
5.2 Arresting means
6 Spacing
7 Movement direction
8 Bow-shaped piece
8.1 First portion
8.2 Second portion
8.3 Third portion
9 Perforated metal plate
10.1, 10.2 Elements
10.3, 10.4 End pieces
11 Locking pin
12 Pivot axis
13 Hole
14 Passage
15 Path boundary
16 Pivot bearing
21 First limb
22 Second limb
23 Fixed bearing
24 Joint
25 Floating bearing
31 First element
32 Second element
33 Third element
34 Angle joint
42 Supporting structure
43 Concertina grille
44 Concertina arm
100 Process start
200 Detection of individual animals
201 Detection area
300 Access database
301 Animal-specific parameters
302 System parameters
400 Data processing
500 Comparison of parameters zᵢ and zᵢ₊₁
600 Activation of the positioning unit
700 Query whether at least one animal is located in the detection area
800 Process end
zᵢ Actual opening width
zᵢ₊₁ Setpoint opening width

1. A path boundary apparatus for directing animal traffic in a movement direction, comprising
a first boundary gate and a second boundary gate, opposite the first boundary gate, which enclose a path between them,
at least one guide unit projecting into the path, wherein the guide unit has a geometry such that a spacing between the guide unit and the second boundary gate is reduced in the movement direction, and
a positioning unit constructed and arranged to alter a position of the guide unit.

2. The path boundary apparatus as claimed in claim 1, wherein the guide unit comprises a bow-shaped piece.

3. The path boundary apparatus as claimed in claim 1, wherein the guide unit is swivel-mounted.

4. The path boundary apparatus as claimed in claim 1, wherein the guide unit comprises at least one joint and one end of the guide unit is displaceable along the first boundary gate in a parallel manner.

5. The path boundary apparatus as claimed in claim 1, wherein the guide unit comprises multiple elements and at least one angle joint and is displaceable relative to a boundary gate.

6. The path boundary apparatus as claimed in claim 1, wherein the guide unit comprises least one concertina grille and is freely displaceable in a horizontal plane.

7. The path boundary apparatus as claimed in claim 1, wherein the positioning unit has an arresting component.

8. A milking system, comprising
at least one milking stall and
an access area to the at least one milking stall, wherein the access area has a path boundary for directing animal traffic in a movement direction, comprising
a first boundary gate and a second boundary gate, opposite the first boundary gate, which enclose a path between them,
at least one guide unit projecting into the path, wherein the guide unit has a geometry such that a spacing from the second boundary gate is reduced as seen in the movement direction,
a positioning unit, which is suitable and intended for altering a position of the guide unit.

9. The milking system as claimed in claim 8, wherein the guide unit comprises a bow-shaped piece.

10. A method for directing animal traffic in a movement direction with a path boundary,
comprising a first boundary gate and a second boundary gate, opposite the first boundary gate, which enclose a path between them, at least one guide unit projecting into the path, wherein this guide unit has a geometry such that a spacing between the guide unit and the second boundary gate is reduced in the movement direction, and
an activatable positioning unit, which is constructed and arranged to alter a position of the guide unit,
comprising the following steps:
detecting animals in a specifiable area;
retrieving at least one animal-specific parameter from a database;
determining a setpoint path width;
comparing the setpoint path width with the actual path width;
activating the positioning unit in the event of a specifiable deviation; and
querying whether at least one further animal is located in the specifiable area.
